(19) United States
(12) Patent Application Publication
(10) Pub. No.: US 2024/0166833 A1
(43) Pub. Date: May 23, 2024

(54) HARD COAT FILM

(71) Applicant: NIPPON PAPER INDUSTRIES CO., LTD., Tokyo (JP)

(72) Inventors: Shin SAITO, Tokyo (JP); Shotaro TOYA, Tokyo (JP); Masahide HASEGAWA, Tokyo (JP)

(73) Assignee: NIPPON PAPER INDUSTRIES CO., LTD., Tokyo (JP)

(21) Appl. No.: 18/284,713

(22) PCT Filed: Mar. 29, 2022
(86) PCT No.: PCT/JP2022/015704

§ 371 Date: Sep. 28, 2023

(30) Foreign Application Priority Data
Mar. 30, 2021 (JP) 2021-058832

(51) Int. Cl. C08J 7/046; B32B 27/08; B32B 27/30; B32B 27/36; C08F 2/50; C08F 220/10; C08F 222/10; C08K 3/36

(52) U.S. Cl. CPC C08J 7/046; B32B 27/08; B32B 27/30; B32B 27/36; C08F 2/50; C08F 220/10; C08F 222/1065; C08K 3/36; B32B 2250/03; B32B 2250/40; B32B 2307/412; B32B 2307/536; B32B 2307/7376; B32B 2333/04; B32B 2367/00; B32B 2457/202; B32B 2457/204; B32B 2457/208; C08J 2333/04

(57) ABSTRACT

A hard coat film having high heat resistance and being excellent in optical properties, hardness, and adhesiveness with hard coat layers. The hard coat film includes hard coat layers on both surfaces of a base material film, and each hard coat layer contains an ionizing radiation curable resin composition. The hard coat film satisfies the following conditions (I), (II), and (III): condition (I): the ionizing radiation curable resin composition contains an acrylic resin including a (meth)acryloyl group; condition (II): the ionizing radiation curable resin composition contains inorganic fine particles or organic fine particles; and condition (III): a peak area ratio 1 ((A/B)×100) is 40% or more (wherein in an infrared spectroscopy spectrum measurement of the ionizing radiation curable resin composition being uncured, A denotes a peak area appearing at 1000 cm⁻¹ to 1120 cm⁻¹, and B denotes a peak area appearing at 1650 cm⁻¹ to 1800 cm⁻¹).

### TECHNICAL FIELD

The present invention relates to a hard coat film, more specifically, to a hard coat film including a hard coat layer, which can be used as members of flat panel displays and touch panels of liquid crystal display devices, plasma display devices, and electroluminescent (EL) display devices, and base films such as carrier films, and flexible substrates.

### BACKGROUND ART

It is required to provide scratch resistance to a display surface of a flat panel display such as a liquid crystal display device (LCD) such that the visibility may not be degraded due to being damaged during handling. Accordingly, it is common to provide scratch resistance by using a hard coat film including a hard coat layer on a base material film. In recent years, with popularization of a touch panel with which a user can input data or instructions by touching a display with a finger or a pen while watching the display on a display screen, a functional demand for a hard coat film maintaining the optical visibility and having the scratch resistance is increasing.

Furthermore, the needs of base films such as carrier films and flexible substrates have become more complicated in recent years, and materials and technologies to achieve new electronics are required. A demand for a film with excellent heat resistance (dimensional stability) with respect to heat and adhesiveness with laminated films to be formed on the films is increasing. Therefore, various types of base material films include a hard coat layer (functional layer) to provide performance that cannot be obtained by the base material films alone, and high-function films that can meet the demand for further high performance are required.

Therefore, as base material films, polyethylene terephthalate, polyethylene naphthalate, triacetylcellulose, and cycloolefins having excellent transparency, heat resistance, dimensional stability, and low moisture absorbency, further polyimides and liquid crystal polymers having excellent dimensional stability are expected to be used for applications of optical members and electronic members. With the diversification of applications in recent years, a hard coat film including a hard coat layer on the base material film for further providing hardness is required not only to have excellent adhesiveness between the base material film and the hard coat layer, but also to have excellent optical properties, heat resistance, and adhesiveness with a laminated film.

Conventionally, for example, PTL 1, PTL 2, and the like, disclose a method for providing a base material film such as a cycloolefin film having particularly excellent optical property with an easy bonding property with a hard coat layer. PTL 1 discloses a method for subjecting a surface of a base film to corona treatment, plasma treatment, UV treatment, and the like, and PTL 2 discloses coating an anchor coat agent to the base material film (anchor coat treatment).

### CITATION LIST

### Patent Literature

### Patent Literature 1: Japanese Patent Application Publication No. 2001-147304

### Patent Literature 1: Japanese Patent Application Publication No. 2006-110875

### SUMMARY OF INVENTION

### Technical Problem

However, it is desired that adhesiveness between a base material film and a hard coat layer can be improved without performing surface treatment or anchor coat treatment of the base material film to provide an easy bonding property with the hard coat layer.

Furthermore, recently, high heat resistance has been required for some applications of hard coat films. In other words, it is required that no degradation in appearance, shape change, or change in optical properties (for example, haze, and the like) occur in hard-coat films after heat treatment.

Thus, an object of the present invention is to provide a hard coat film having high heat resistance, and being excellent in optical properties, hardness (scratch resistance, pencil hardness, and the like), and adhesiveness with a hard coat layer.

### Solution to Problem

The present inventors have conducted earnest studies to solve the above-mentioned problems, focused on the characteristics (peak area ratio) in infrared spectroscopy spectrum of a resin composition contained in a hard coat layer, and found that these characteristics in the infrared spectroscopy spectrum especially contributed to heat resistance of the hard coat film and improvement of adhesiveness with the hard coat layer, and the like. Then, the present inventors have found that by providing a hard coat layer having characteristics of this infrared spectroscopy spectrum, a hard coat film excellent in heat resistance, and further optical properties, and hardness (scratch resistance, pencil hardness, and the like), adhesiveness with the hard coat layer, can be obtained, and have reached the completion of the present invention.

In other words, the present invention includes the following configurations.

(First Invention)

A hard coat film including hard coat layers on both surfaces of a base material film, each hard coat layer containing an ionizing radiation curable resin composition, the hard coat film satisfying the following conditions (I), (II), and (III):
condition (I): the ionizing radiation curable resin composition contains an acrylic resin including a (meth)acryloyl group;
condition (II): the ionizing radiation curable resin composition contains inorganic fine particles or organic fine particles; and
condition (III): a peak area ratio 1 ((A/B)×100) is 40% or more
(wherein in an infrared spectroscopy spectrum measurement of the ionizing radiation curable resin composition being uncured, A denotes a peak area appearing at 1000 cm⁻¹ to 1120 cm⁻¹, and B denotes a peak area appearing at 1650 cm⁻¹ to 1800 cm⁻¹).

(Second Invention)

The hard coat film according to the first invention, wherein the ionizing radiation curable resin composition further satisfies the following condition (IV):
condition (IV): a peak area ratio 2 ((C/B)×100) is 5% or more
(wherein in the infrared spectroscopy spectrum measurement of the ionizing radiation curable resin composition being uncured, C denotes a peak area appearing at 3250 cm⁻¹ to 3500 cm⁻¹, and B denotes a peak area appearing at 1650 cm⁻¹ to 1800 cm⁻¹).

(Third Invention)

The hard coat film according to the first or second invention, wherein the ionizing radiation curable resin composition further satisfies the following condition (V):
condition (V): a peak area ratio 3 ((D/B)×100) is 30% or less
(wherein in the infrared spectroscopy spectrum measurement of the ionizing radiation curable resin composition being uncured, D denotes a peak area appearing at 1500 cm⁻¹ to 1580 cm⁻¹, and B denotes a peak area appearing at 1650 cm⁻¹ to 1800 cm⁻¹).

(Fourth Invention)

The hard coat film according to any one of the first to third inventions, wherein the ionizing radiation curable resin composition further satisfies the following condition (VI):
condition (VI): a peak area ratio 4 ((E/B′)×100) is 20% or less,
(wherein in infrared spectroscopy spectrum measurement of the ionizing radiation curable resin composition being cured, E denotes a peak area appearing at 1370 cm⁻¹ to 1435 cm⁻¹, and B′ denotes a peak area appearing at 1650 cm⁻¹ to 1800 cm⁻¹).

(Fifth Invention)

The hard coat film according to any one of the first to fourth inventions, wherein a content of the inorganic fine particles or the organic fine particles is in a range from 1% by mass to 60% by mass relative to a solid content of the ionizing radiation curable resin composition.

(Sixth Invention)

The hard coat film according to any one of the first to fifth inventions, wherein a film thickness D_{A} of a hard coat layer A and a film thickness D_{B} of a hard coat layer B are both in a range from 0.5 μm to 12.0 μm wherein D_{A} denotes a film thickness of the hard coat layer A being a first surface of the base material film and D_{B} denotes a film thickness of the hard coat layer B being a second surface of the base material film.

(Seventh Invention)

The hard coat film according to any one of the first to sixth inventions, wherein a film thickness ratio ((D_{A}/D_{B})×100) of the hard coat layer A to the hard coat layer B is in a range from 50% to 150%.

(Eighth Invention)

The hard coat film according to any one of the first to seventh inventions, wherein the base material film is any one selected from polyethylene terephthalate, cycloolefin, polyethylene naphthalate, polyimide, triacetylcellulose, and liquid crystal polymer.

### Advantageous Effects of Invention

The present invention can provide a hard coat film having high heat resistance and being excellent in optical properties, hardness (scratch resistance, pencil hardness, and the like), and adhesiveness with a hard coat layer.

### DESCRIPTION OF EMBODIMENTS

Hereinafter, embodiments for carrying out the present invention will be described in detail, but the present invention is not limited to the following embodiments.

Note here that in the present specification, unless especially stated otherwise, “from xx to yy” means “xx or more and yy or less”.

The present invention is, as described in the above first invention, a hard coat film including hard coat layers on both surfaces of a base material film, each hard coat layer containing an ionizing radiation curable resin composition, the hard coat film satisfying the following conditions (I), (II), and (III):
condition (I): the ionizing radiation curable resin composition contains an acrylic resin including a (meth)acryloyl group;
condition (II): the ionizing radiation curable resin composition contains inorganic fine particles or organic fine particles; and
condition (III): a peak area ratio 1 ((A/B)×100) is 40% or more
(wherein in an infrared spectroscopy spectrum measurement of the ionizing radiation curable resin composition being uncured, A denotes a peak area appearing at 1000 cm⁻¹ to 1120 cm⁻¹, and B denotes a peak area appearing at 1650 cm⁻¹ to 1800 cm⁻¹).

Hereinafter, the configuration of the hard coat film of the present invention will be described in detail.

[Base Material Film]

Firstly, a base material film of a hard coat film according to the present invention will be described.

In the present invention, the base material film of the hard coat film is not particularly limited, and examples thereof can include films, sheets, or the like, of polyethylene terephthalate, polyimide, polyethylene, polypropylene, acrylic resin, polystyrene, triacetylcellulose, and polyvinyl chloride. Especially, polyethylene terephthalate, cycloolefin, polyethylene naphthalate, and polyimide, triacetylcellulose, and liquid crystal polymer, which have excellent heat resistance, dimensional stability, and the like, are preferable. Especially, polyethylene terephthalate that is inexpensive and easily available, and cycloolefin having excellent optical properties and low moisture absorbency are further preferable.

Further, in the present invention, a thickness of the base material film is appropriately selected according to an application to which the hard coat film is used, but from the viewpoint of mechanical strength, handling property, and the like, the thickness is preferably in the range from 10 μm to 300 μm, and more preferably in the range from 20 μm to 200 μm.

In the present invention, when the base material film is used for an application of a hard coat film, for the purpose of preventing a coated film from deteriorating or causing adhesion failure due to ultraviolet rays, a film obtained by forming a resin in which a resin constituting a base material film and a ultraviolet my-absorbing agent are kneaded into a shape of film or a film obtained by coating one surface or both surfaces of the base material film with a coating material obtained by mixing a thermoplastic or thermosetting resin and a UV-absorbing agent may be used.

[Hard Coat Layer]

Next, the aforementioned hard coat layer will be described.

In the present invention, the hard coat layer contains an ionizing radiation curable resin composition. The hard coat layer is formed of a cured coating film of the ionizing radiation curable resin composition.

As the resin contained in the hard coat layer, an ionizing radiation curable resin is preferably used, in particular, from the viewpoint of providing surface hardness (pencil hardness, scratch resistance) of the hard coat layer, being capable of adjusting a degree of crosslinking by an exposure amount of ultraviolet ray, and being capable of adjusting the surface hardness of the hard coat layer.

In the present invention, the ionizing radiation curable resin composition contains an acrylic resin including a (meth)acryloyl group (the condition (I) mentioned above).

The ionizing radiation curable resin composition used in the present invention is a transparent resin that is cured by irradiation with ultraviolet rays (hereinafter, abbreviated as “UV”) or an electron beam (hereinafter, abbreviated as “EB”), preferably includes an acrylic resin including a (meth)acryloyl group, and more preferably is a urethane acrylate resin including a (meth)acryloyl group.

As described previously, the present inventors focused on the characteristics (peak area ratio) in the infrared spectroscopy spectrum of a resin composition contained in the hard coat layer, and found that the characteristics of the infrared spectroscopy spectrum contributed especially to the heat resistance of the hard coat film and improvement of the adhesiveness with the hard coat layer.

In other words, in the ionizing radiation curable resin composition used in the present invention, it is important that a peak area ratio 1 ((A/B)×100) is 40% or more, wherein in the infrared spectroscopy spectrum measurement of the ionizing radiation curable resin composition being in an uncured state, A denotes a peak area (an area in a peak range) appearing at 1000 cm⁻¹ to 1120 cm⁻¹, and B denotes a peak area (an area in a peak range) appearing at 1650 cm⁻¹ to 1800 cm⁻¹ (the condition (III) mentioned above). The peak area ratio 1 is preferably in a range from 50% to 400%.

The ionizing radiation curable resin composition used in the present invention further contains inorganic fine particles or organic fine particles (the condition (II) mentioned above).

In this case, the peak appearing at 1000 to 1120 cm⁻¹ in the infrared spectroscopy spectrum in the ionizing ray radiation curable resin being uncured is assumed to represent the above inorganic fine particles such as nanosilica or the above organic fine particles such as silicon-oxygen bond derived from silicone resin. Further, the peak appearing at 1650 to 1800 cm⁻¹ in the infrared spectroscopy spectrum represents a peak of the carbon-oxygen stretching vibration derived from a (meth)acryloyl group.

In other words, the presence of a peak appearing at 1000 cm⁻¹ to 1120 cm⁻¹ at a certain percentage or more relative to the presence percentage of the (meth)acryloyl group means that many silicon-oxygen bonds are included in the hard coat layer having high binding energy and excellent thermal stability, and is assumed to contribute to improvement of the heat resistance of the hard coat layer. This is thought to be able to improve the heat resistance of the hard coat film.

As mentioned above, the ionizing radiation curable resin composition used in the present invention further contains inorganic fine particles or organic fine particles. Containing inorganic fine particles or organic fine particles enables the surface hardness (scratch resistance) or surface smoothness of the hard coat layer to be improved. In addition, as described above, it contributes to improvement of the heat resistance of the hard coat film.

In this case, the average particle diameter of the inorganic fine particles or organic fine particles is preferably in a range from 1 to 150 nm, and further preferably in a range from 10 to 100 nm. The average particle diameter of less than 1 nm makes it difficult to obtain sufficient surface hardness. On the other hand, the average particle diameter of more than 150 nm may deteriorate gloss and transparency of the hard coat layer, and may also deteriorate flexibility.

Examples of the inorganic fine particles can preferably include silica, alumina, and the like. Examples of the organic fine particles can preferably include silicone resin and the like.

In the present invention, it is particularly suitable to contain silica that is an inorganic fine particle with a very high binding energy and excellent thermal stability.

In the present invention, a content of the inorganic fine particles or organic fine particles is preferably in a range from 1 to 60% by mass, and particularly preferably in a range from 15 to 50% by mass relative to a solid content of the ionizing radiation curable resin composition. When the content is less than 1% by mass, it is difficult to obtain an improvement effect of the surface hardness (scratch resistance) or an improvement effect of the heat resistance. On the other hand, it is not preferable when the content is more than 60% by mass, because flexibility is deteriorated or haze is increased.

Furthermore, it is preferable that the ionizing radiation curable resin composition used in the present invention further satisfies the following condition (IV).

In other words, it is preferable that a peak area ratio 2 ((C/B)×100) of 5% or more is satisfied, wherein in the infrared spectroscopy spectrum measurement of the ionizing radiation curable resin composition being uncured, C denotes a peak area (an area of a peak range) appearing at 3250 cm⁻¹ to 3500 cm⁻¹, and B denotes a peak area (an area of a peak range) appearing at 1650 cm⁻¹ to 1800 cm⁻¹ (condition (IV)). The peak area ratio 2 is preferably 5% to 400%.

In the ionizing ray radiation curable resin composition being uncured, the peak appearing at 1650 cm⁻¹ to 1800 cm⁻¹ in the infrared spectroscopy spectrum represents a peak of the carbon-oxygen stretching vibration derived from a (meth)acryloyl group. Furthermore, the peak appearing at 3250 cm⁻¹ to 3500 cm⁻¹ in the infrared spectroscopy spectrum is assumed to represent a nitrogen-hydrogen bond derived from an amide group or an oxygen-hydrogen bond derived from a hydroxyl group.

In other words, with the presence of peaks appearing at 3250 cm⁻¹ to 3500 cm⁻¹ at a certain percentage or more relative to the presence percentage of the (meth)acryloyl group, it is assumed that the adhesion force of the hard coat layer with respect to the base material by a (meth)acryloyl group, and the peeling force, by which the hard coat layer is peeled when the hard coat layer undergoes curing contraction in the layer and force is applied in a direction different from the interface of the base material film, are kept in balance, so it is assumed that the adhesiveness with the hard coat layer to the base material film can be improved for each type of base material film including cycloolefin film with few polar groups, without requiring modification of the anchor layer or the base material film.

Furthermore, it is preferable that the ionizing radiation curable resin composition used in the present invention further satisfies the following condition (V).

That is, in the infrared spectroscopy spectrum measurement of the ionizing radiation curable resin composition being uncured, it is preferable that the peak area ratio 3 ((D/B)×100) of 30% or less is satisfied wherein D denotes a peak area (an area of a peak range) appearing at 1500 cm⁻¹ to 1580 cm⁻¹, and B denotes a peak area (an area of a peak range) appearing at 1650 cm⁻¹ to 1800 cm⁻¹ (condition (V)). The peak area ratio 3 is particularly preferably 0.5% to 10%.

It is assumed that in the ionizing ray radiation curable resin composition being uncured, the peak appearing at 1500 cm⁻¹ to 1580 cm⁻¹ 1 of the infrared spectroscopy spectrum is a nitrogen-hydrogen bond derived from an amide group, a carbon-hydrogen bond derived from the phenyl ring, or a nitrogen-nitrogen double bond derived from the azo group. Furthermore, as mentioned above, the peak appearing at 1650 cm⁻¹ to 1800 cm⁻¹ of the infrared spectroscopy spectrum represents a peak of the carbon-oxygen stretching vibration derived from the (meth)acryloyl group.

In other words, with the presence of peaks appearing at 1500 cm⁻¹ to 1580 cm⁻¹ at a certain percentage or more relative to the presence percentage of the (meth)acryloyl group, it is assumed that hardness of the hard coat layer with respect to the base material film can be further improved.

Furthermore, it is preferable that the ionizing radiation curable resin composition used in the present invention further satisfies the following condition (VI).

That is, it is preferable in the infrared spectroscopy spectrum measurement of the ionizing radiation curable resin composition in a cured state that a peak area ratio 4 ((E/B′)×100) of 20% or less is satisfied, wherein E denotes a peak area appearing at 1370 cm⁻¹ to 1435 cm⁻¹, and B′ denotes the peak area appearing at 1650 cm⁻¹ to 1800 cm⁻¹ (condition (VI)). The peak area ratio 4 is particularly preferably 0.5% to 10%.

The peak appearing at 1370 cm⁻¹ to 1435 cm⁻¹ in the infrared spectrum in the infrared spectroscopy spectrum represents a carbon-carbon double bond derived from a (meth)acryloyl group. Also, the peak appearing at 1650 cm⁻¹ to 1800 cm⁻¹ in the infrared spectrum represents a peak of the carbon-oxygen stretching vibration derived from the (meth)acryloyl group. Therefore, the peak area ratio 4 by the ionizing radiation curable resin composition being cured in the infrared spectroscopy spectrum measurement represents the presence ratio of a carbonyl group relative to a (meth)acryloyl group, and shows the progressing degree of curing of the hard coat layer.

In other words, it is assumed that as the numeric value of this peak area ratio 4 is larger, unreacted (meth)acryloyl groups are left, the uncured components are increased in the hard coat layer, and as a result, the rigidity of the hard coat layer is reduced, and the ability to suppress the thermal deformation of the base material film can be reduced. In the present invention, the peak area ratio 4 of 20% or less can suppress reduction of rigidity of the hard coat layer or reduction of suppressing force of thermal deformation of the base material film, and can contribute to improvement of heat resistance of the hard coat film.

Furthermore, the ionizing radiation curable resin composition may include a thermoplastic resin such as polyethylene, polypropylene, polystyrene, polycarbonate, polyester, styrene-acrylic, or fibrin, or a thermosetting resin such as a phenolic resin, a urea resin, unsaturated polyester, epoxy, or a silicon resin, in addition to the acrylic resin including a (meth)acryloyl group, within a range that does not damage the effect of the present invention, the hardness of the hard coat layer, or the scratch resistance.

Further, a photopolymerization initiator of the ionizing radiation curable resin composition is not particularly limited, and acetophenones such as commercially available Omnirad 651 and Omnirad 184 (both are trade names, manufactured by IMG) and benzophenones such as Omnirad 500 (trade name, manufactured by IMG) can be used.

[Hard Coat Film]

The hard coat film of the present invention is a hard coat film in which a hard coat layer is formed on both surfaces of a base material film using an ionizing radiation curable resin composition that satisfies the conditions described above.

For the hard coat layer, a levelling agent may be used to improve the coating property. Examples thereof include the well-known levelling agents such as a fluorine-based levelling agent, an acrylic-based levelling agent, a siloxane-based levelling agent, and adducts or mixtures thereof. As a blending amount, the levelling agent may be blended in the range from 0.01 parts by mass to 7 parts by mass relative to 100 parts by mass of the solid content of the hard coat layer. Further, in applications to touch panels or the like, in the case where an anti-bonding property using an optically transparent resin OCR is required for the purpose of bonding with a cover glass (CG), a transparent conductive member (TSP), a liquid crystal module (LCM), or the like, of a touch panel terminal, an acrylic-based levelling agent or a fluorine-based levelling agent having high surface free energy (about 40 mJ/cm² or higher) is preferably used.

As the other additives to be added to the hard coat layer, a defoaming agent, a surface tension controlling agent, an antifouling agent, an antioxidant, an antistatic agent, a UV-absorbing agent, a light stabilizer, or the like, may be added if necessary in the range that does not damage the effect of the present invention.

The hard coat layer is formed by coating the base material film with a coating material obtained by dissolving or dispersing the ionizing radiation curable resin composition, a photopolymerization initiator, and other additives in an appropriate solvent, followed by drying. As the solvent, any solvent can be appropriately selected according to the solubility of a resin to be blended and may be a solvent capable of uniformly dissolving or dispersing at least the solid content (resin, polymerization initiator, and other additives). As such a solvent, well-known organic solvents, for example, aromatic-based solvents such as toluene, xylene, and n-heptane; aliphatic-based solvents such as cyclohexane, methyl cyclohexane, and ethyl cyclohexane; ester-based solvents such as methyl acetate, ethyl acetate, propyl acetate, isopropyl acetate, butyl acetate, and methyl lactate; ketone-based solvents such as acetone, methyl ethyl ketone, methyl isobutyl ketone, and cyclohexanone; and alcohol-based solvents such as methanol, ethanol, isopropyl alcohol, and n-propyl alcohol can be used alone or also in a combination of an appropriate number.

The coating method of the hard coat layer is not particularly limited. A well-known coating method such as a gravure coating, a micro gravure coating, a fountain-bar coating, a slide die coating, a slot die coating, a screen printing method, or a spray coating method may be used for coating, followed by drying usually at a temperature of from about 50 to 120° C.

In the present invention, a cured coating film (hard coat layer) excellent in hardness can be obtained in which a hard coat layer coating material containing the ionizing radiation curable resin composition or the like is coated on the base material film and dried, followed by irradiation with ionizing radiation rays (UV, EB, or the like) to cause photopolymerization. Particularly, the hard coat layer having the pencil hardness of 3B to 3H in accordance with JIS K5600-5-4 is preferable. The irradiation amount of the ionizing radiation (UV, EB, or the like) to the dried coating film is only required to be an irradiation amount that need to bring sufficient hardness to the hard coat layer, and the amount can be appropriately set according to types or the like of the ionizing radiation curable resin.

The hard coat film of the present invention is a hard coat film including hard coat layers on both surfaces of a base material film.

A film thickness of the hard coat layer is not particularly limited, but a film thickness D_{A} of a hard coat layer A and a film thickness D_{B} of a hard coat layer B are both in a range from 0.5 μm to 12.0 μm, and particularly preferably in a range from 1.0 μm to 9.0 μm, wherein D_{A} denotes a film thickness of the hard coat layer A being a first surface of the base material film and D_{B} denotes a film thickness of the hard coat layer B being a second surface of the base material film. When the film thickness is less than 0.5 μm, sufficient rigidity with respect to the hard coat layer cannot be obtained, and it becomes difficult to suppress thermal deformation of the base material film by the hard coat layer. Also, it is not preferable that the film thickness is more than 12.0 μm because the rigidity of the hard coat layer is remarkably improved, and the bending property and crack resistance of the hard coat layer decreases significantly. In order to keep balance therebetween, the film thickness is preferably in a range from 5.0 μm to 7.0 μm.

Furthermore, a film thickness ratio ((D_{A}/D_{B})×100) of the hard coat layer A to the hard coat layer B is preferably in a range from 50% to 150%, and particularly preferably 80% to 120%. It is preferable that when the film thickness ratio of the hard coat layer A to the hard coat layer B is in the above ratio, curls of the hard coat layers A and B with curing contraction are offset.

As described above, the present invention can provide a hard coat film including hard coat layers on both surfaces of a base material film, in which each hard coat layer contains an ionizing radiation curable resin composition, and the hard coat film satisfies the above-mentioned conditions (I), (II), and (III). The present invention can provide a hard coat film having high heat resistance and being excellent in optical properties, hardness (scratch resistance, pencil hardness, and the like), and adhesiveness with the hard coat layer.

Furthermore, it is further preferable that the hard coat film of the present invention satisfies the conditions (IV) and/or (V) and/or (VI).

### EXAMPLES

Hereinafter, the present invention will be specifically described with reference to Examples, but the present invention is not limited to the following Examples. Also, Comparative Examples will be specifically described.

Note here that unless otherwise particularly noted, “parts” described below represent “parts by mass”, and “%” described below represent “% by mass”.

### Example 1

### [Preparation of Resin Composition 1 for Forming Hard Coat Layer (Coating Material for Hard Coat Layer)]

A fluorine-based leveling agent was added to an ionizing radiation curable resin composition (containing a total 23% of urethane acrylate and acrylic ester, 15% amorphous silica, and 2% photopolymerization initiator, and a solvent containing 35% propylene glycol monomethyl ether, 15% methyl ethyl ketone and 10% toluene) so that a solid content ratio was 0.1% was used as a main component, and the solid content was adjusted to 25% with a diluent (a diluent including 70% 1-propanol and 30% diacetone alcohol).

As mentioned above, the resin composition 1 for forming a hard coat layer to be used for this Example was prepared.

[Production of Hard Coat Film]

A base material film (trade name: “Cosmoshine A 4360”, thickness: 125 μm, manufactured by Toyobo Co., Ltd.) mainly including polyethylene terephthalate was used as a base material film, and a resin composition 1 for forming a hard coat layer mentioned above was coated on both surfaces of the base material film using a bar coater and then hot-air-dried in a drying furnace at 80° C. for 1 minute to form a coated layer having a coating thickness of 3.0 μm (one side). Note here that the coating film thickness was the same on both surfaces. The coating film thickness was measured using a Thin-Film Analyzer F20 (trade name) (manufactured by FILMETRICS).

The obtained product was cured with a UV irradiation device set at a height of 60 mm above the coating surface at a UV irradiation dose of 157 mJ/cm² to form hard coat layers on both surfaces of a base film to obtain a hard coat film of Example 1.

### Example 2

A hard coat film of Example 2 was produced by the same manner as in Example 1 except that a coating film thickness (one side) in Example 1 was 6.0 μm

### Comparative Example 1

A fluorine-based leveling agent was added to an ionizing radiation curable resin composition (containing 95% polyester acrylate ultraviolet curable resin “M7300K” (solid content: 100%, manufactured by Toa Synthetic Co., Ltd.) and 5% photopolymerization initiator) such that a solid content ratio became 0.1% to obtain a main agent. The solid content thereof was adjusted to 45% with a diluent (a diluent obtained by mixing 40% 1-propanol and 60% propyl acetate).

The resin composition 2 for forming a hard coat layer was prepared as mentioned above.

A hard coat film of Comparative Example 1 was produced by the same method as in Example 1 except that the resin composition 2 for forming a hard coat layer was used.

### Reference Example

As a Reference Example, a base material film (trade name: Cosmoshine A 4360, thickness: 125 μm, manufactured by Toyobo Co., Ltd.) mainly including polyethylene terephthalate used for the Example and Comparative Example was evaluated as follows.

<Evaluation Method>

The respective hard coat films of Examples and Comparative Examples obtained as described above and the base material film of Reference Example were evaluated according to the following methods and criteria, and results thereof are summarized in Tables 1 and 2.

(1) Peak Area and Peak Area Ratio of Ionizing Radiation Curable Resin Composition

An infrared spectrum (infrared absorption spectrum) was measured using an infrared spectrophotometer by the ATR method for the ionizing radiation curable resin composition being uncured (the resin used for the hard coat layer). As the infrared spectrophotometer, FT-IR Spectrometer Spectrum 100 (manufactured by Perkin Elmer Japan) was used.

As a measurement method, the base material film coated with the resin composition for forming a hard coat layer was dried in a drying furnace at 80° C. for 3 hours, and then the coated surface was brought into contact with a measurement site (sensor part) of the infrared spectrophotometer in an environment at a temperature of 23° C. and humidity of 50%, to measure the infrared spectroscopy spectrum.

On the resulting spectrum chart with the horizontal axis representing the wave number (cm⁻¹) and the vertical axis representing the absorbance, the baselines were drawn at 1000 to 1120 cm⁻¹, 1650 to 1800 cm⁻¹, 3250 to 3500 cm⁻¹, and 1500 to 1580 cm⁻¹, respectively, and the areas surrounded by the baselines and the spectrum curves were defined as the peak areas A, B, C, and D, respectively, and the ratios ((A/B)×100), ((C/B)×100), and ((D/B)×100) were defined as the peak area ratios 1, 2, and 3, respectively.

Also, the infrared spectrophotometer was used to measure the infrared spectrum (infrared absorption spectrum) by the ATR method on the surface of the hard coat layer (the ionizing radiation curable resin composition after cured) of the hard coat film. As the measurement method, the surface of the hard coat layer was brought into contact with the measurement site (sensor part) of the infrared spectrophotometer under the environment at a temperature of 23° C. and humidity of 30%, and the infrared spectrum was measured.

On the resulting spectrum chart with the horizontal axis representing the wave number (cm⁻¹) and the vertical axis representing the absorbance, the baselines were drawn at 1370 to 1435 cm⁻¹, and 1650 to 1800 cm⁻¹, respectively, and the areas surrounded by the baselines and the spectrum curves were defined as the peak areas E, and B′, and the ratio ((F/B′)×100) was defined as the peak area ratio 4.

The above results are summarized in Table 1.

(2) Optical Properties (Transmittance, Haze)

Measurement was carried out by using “haze meter HM150” (manufactured by Murakami Color Research Laboratory Co., Ltd.) in accordance with JIS-K-7361-1 and JIS-K-7136.

(3) Scratch Resistance

For each of the hard coat films, a hard coat layer surface (a base material film surface in a case of Reference Example) was subjected to ten times of reciprocation friction tests using steel wool #0000 under a load of 250 g/cm² by a test method in accordance with JIS-K-5600-5-10, and a damage degree was evaluated according to the following criteria. Herein, test samples evaluated as ◯ was determined to have excellent scratch resistance (acceptable).

◯: no scratches

Δ: slight scratches (1 to 9)

X: innumerable scratches (more than 10)

(4) Pencil Hardness

The pencil hardness of each of the hard coat films was measured by a test method in accordance with JIS K5600-5-4. The hardness that does not generate scratch on a surface was recorded and shown in Table 1.

(5) Adhesiveness

The adhesiveness was evaluated by a crosscut peeling test in accordance with JIS-K5600-5-6. Specifically, for each hard coat film, under normal condition (23° C., 50% RH), 100 crosscuts of 1 mm² were produced using a crosscut peeling test jig, an adhesive tape No. 252 manufactured by Sekisui Chemical Co., Ltd. was stuck thereon, and uniformly pressed using a spatula, followed by peeling in a 60-degree direction. Pressure bonding and peeling were carried out five time in the same place. Then, residual number of the hard coat layers was evaluated in three stages. Evaluation criteria are as follows.

◯: 100 (no peeling was observed)

Δ: 99 to 90 (slight peeling was observed)

X: 89 to 0 (peeling was observed)

All of the evaluation results related to the optical properties, scratch resistance, pencil hardness, and adhesiveness mentioned above are summarized in Table 1.

(6) Heat Resistance

Each hard coat film was placed on a stainless steel plate with A-surface of one of the hard coat layers facing upward (in the case of Reference Example, the base material film was placed on the stainless steel plate), was heat-treated in a drying furnace of the constant temperature dryer DY 300 (manufactured by Yamato Science Co., Ltd.) for a certain period of time, and then, the appearance, deformation, and delta ΔHaze of each film after the heat treatment were evaluated, respectively. Note here that heat treatment was carried out in three conditions, at 150° C. for 30 minutes, at 200° C. for 30 minutes, and at 240° C. for 10 minutes.

[Evaluation of Appearance]

Appearance and look (degree of whitening of a film surface, degree of precipitation of oligomer components from the inside of the base material film, and the like) of each film before and after heat treatment were compared and evaluated visually.

The evaluation criteria are as follows:
◯: No change was observed, A: Slight change was observed, X: Change was observed

[Evaluation of Deformation]

A shape change (film curvature (deformation), cracks (fracture) in the hard coat layer, and the like) that occurred in each film after heat treatment were evaluated visually. The evaluation criteria are as follows.
◯: no occurrence, A: slight occurrence, X: occurred

[ΔHaze]

The value obtained by subtracting the haze of each film before heat treatment (untreated) from the haze of each film after heat treatment was defined as Δhaze. Note here that the Haze was measured using a haze meter HM 150 (manufactured by Murakami Institute of Color Technology, Inc.) in accordance with JIS-K-7136 as described above.

The results of the heat resistance evaluation are summarized in Table 2.

TABLE 1

| | Optical | | | | | | | | |
|---|---|---|---|---|---|---|---|---|---|
| | properties | | | | | Peak area ratio | | | |
| | Trans- | | Mechanical physical properties | | | Area ratio 1 | Area ratio 2 | Area ratio 3 | Area ratio 4 |
| | mittance | Haze | Scratch | Pencil | Adhe- | (A/B) × 100 | (C/B) × 100 | (D/B) × 100 | (E/B′) × 100 |
| | % | % | resistance | hardness | siveness | 40%≤ | 5%≤ | ≤30% | ≤20% |
| Ref. Ex. | 90.8 | 1.1 | X | <6B | — | — | — | — | — |
| Co. Ex. 1 | 92.1 | 0.2 | Δ | H | ◯ | 10% | 0% | 3% | 9% |
| Ex. 1 | 92.2 | 0.4 | ◯ | H | ◯ | 93% | 7% | 5% | 5% |
| Ex. 2 | 92.2 | 0.5 | ◯ | 2H | ◯ | 92% | 7% | 5% | 5% |

Ref. Ex = Reference Example
Co. Ex. = Comparative Example
Ex = Example

TABLE 2

| | Heat resistance | | | | | | | | |
|---|---|---|---|---|---|---|---|---|---|
| | After heat treatment | | | After heat treatment | | | After heat treatment | | |
| | at 150° C. for 30 min | | | at 200° C. for 30 min | | | at 240° C. for 10 min | | |
| | 1. | 2. | | 1. | 2. | | 1. | 2. | |
| | Appear- | Defor- | 3. | Appear- | Defor- | 3. | Appear- | Defor- | 3. |
| | ance | mation | ΔHaze | ance | mation | ΔHaze | ance | mation | ΔHaze |
| Ref. Ex. | X | Δ | 17.6 | X | X | 9.7 | X | X | 1.3 |
| Co. Ex. 1 | ◯ | ◯ | 0.0 | ◯ | Δ | 0.1 | ◯ | X | 0.2 |
| Ex. 1 | ◯ | ◯ | 0.0 | ◯ | ◯ | 0.0 | ◯ | Δ | 0.3 |
| Ex. 2 | ◯ | ◯ | 0.0 | ◯ | ◯ | 0.0 | ◯ | ◯ | 0.1 |

Ref. Ex = Reference Example
Co. Ex. = Comparative Example
Ex = Example

As is apparent from the results of Table 1 and Table 2, Examples of the present invention satisfying the conditions (I), (II), and (III) of the present invention can provide a hard coat film having high heat resistance and being excellent in optical properties, hardness (scratch resistance, pencil hardness, and the like), and adhesiveness with the hard coat layers.

On the other hand, in the Comparative Example that does not satisfy any one of the conditions (I), (II), and (III) of the present invention, a hard coat film which satisfies all of heat resistance, optical properties, hardness (scratch resistance, pencil hardness, and the like), and adhesiveness with the hard coat layer cannot be obtained. In the Comparative Example, heat resistance is particularly insufficient.

1. A hard coat film comprising hard coat layers on both surfaces of a base material film, each hard coat layer containing an ionizing radiation curable resin composition, the hard coat film satisfying the following conditions (I), (II), and (III):
condition (I): the ionizing radiation curable resin composition contains an acrylic resin including a (meth)acryloyl group;
condition (II): the ionizing radiation curable resin composition contains inorganic fine particles or organic fine particles; and
condition (III): a peak area ratio 1 ((A/B)×100) is 40% or more,
wherein in an infrared spectroscopy spectrum measurement of the ionizing radiation curable resin composition being uncured, A denotes a peak area appearing at 1000 cm⁻¹ to 1120 cm⁻¹, and B denotes a peak area appearing at 1650 cm⁻¹ to 1800 cm⁻¹.

2. The hard coat film according to claim 1, wherein the ionizing radiation curable resin composition further satisfies the following condition (IV):
condition (IV): a peak area ratio 2 ((C/B)×100) is 5% or more,
wherein in the infrared spectroscopy spectrum measurement of the ionizing radiation curable resin composition being uncured, C denotes a peak area appearing at 3250 cm⁻¹ to 3500 cm⁻¹, and B denotes a peak area appearing at 1650 cm⁻¹ to 1800 cm⁻¹.

3. The hard coat film according to claim 1, wherein the ionizing radiation curable resin composition further satisfies the following condition (V):
condition (V): a peak area ratio 3 ((D/B)×100) is 30% or less,
wherein in the infrared spectroscopy spectrum measurement of the ionizing radiation curable resin composition being uncured, D denotes a peak area appearing at 1500 cm⁻¹ to 1580 cm⁻¹, and B denotes a peak area appearing at 1650 cm⁻¹ to 1800 cm⁻¹.

4. The hard coat film according to claim 1, wherein the ionizing radiation curable resin composition further satisfies the following condition (VI):
condition (VI): a peak area ratio 4 ((E/B′)×100) is 20% or less,
wherein in the infrared spectroscopy spectrum measurement of the ionizing radiation curable resin composition being cured, E denotes a peak area appearing at 1370 cm⁻¹ to 1435 cm⁻¹, and B′ denotes a peak area appearing at 1650 cm⁻¹ to 1800 cm⁻¹.

5. The hard coat film according to claim 1, wherein a content of the inorganic fine particles or the organic fine particles is in a range from 1% by mass to 60% by mass relative to a solid content of the ionizing radiation curable resin composition.

6. The hard coat film according to claim 1, wherein a film thickness D_{A} of a hard coat layer A and a film thickness D_{B} of a hard coat layer B are both in a range from 0.5 μm to 12.0 μm wherein D_{A} denotes a film thickness of the hard coat layer A being a first surface of the base material film and D_{B} denotes a film thickness of the hard coat layer B being a second surface of the base material film.

7. The hard coat film according to claim 1, wherein a film thickness ratio ((D_{A}/D_{B})×100) of the hard coat layer A to the hard coat layer B is in a range from 50% to 150%.

8. The hard coat film according to claim 1, wherein the base material film is any one selected from polyethylene terephthalate, cycloolefin, polyethylene naphthalate, polyimide, triacetylcellulose, and liquid crystal polymer.

9. The hard coat film according to claim 2, wherein the ionizing radiation curable resin composition further satisfies the following condition (V):
condition (V): a peak area ratio 3 ((D/B)×100) is 30% or less,
wherein in the infrared spectroscopy spectrum measurement of the ionizing radiation curable resin composition being uncured, D denotes a peak area appearing at 1500 cm⁻¹ to 1580 cm⁻¹, and B denotes a peak area appearing at 1650 cm⁻¹ to 1800 cm⁻¹.

10. The hard coat film according to claim 2, wherein the ionizing radiation curable resin composition further satisfies the following condition (VI):
condition (VI): a peak area ratio 4 ((E/B′)×100) is 20% or less,
wherein in the infrared spectroscopy spectrum measurement of the ionizing radiation curable resin composition being cured, E denotes a peak area appearing at 1370 cm⁻¹ to 1435 cm⁻¹, and B′ denotes a peak area appearing at 1650 cm⁻¹ to 1800 cm⁻¹.

11. The hard coat film according to claim 3, wherein the ionizing radiation curable resin composition further satisfies the following condition (VI):
condition (VI): a peak area ratio 4 ((E/B′)×100) is 20% or less,
wherein in the infrared spectroscopy spectrum measurement of the ionizing radiation curable resin composition being cured, E denotes a peak area appearing at 1370 cm⁻¹ to 1435 cm⁻¹, and B′ denotes a peak area appearing at 1650 cm⁻¹ to 1800 cm⁻¹.

12. The hard coat film according to claim 9, wherein the ionizing radiation curable resin composition further satisfies the following condition (VI):
condition (VI): a peak area ratio 4 ((E/B′)×100) is 20% or less,
wherein in the infrared spectroscopy spectrum measurement of the ionizing radiation curable resin composition being cured, E denotes a peak area appearing at 1370 cm⁻¹ to 1435 cm⁻¹, and B′ denotes a peak area appearing at 1650 cm⁻¹ to 1800 cm⁻¹.

13. The hard coat film according to claim 2, wherein a content of the inorganic fine particles or the organic fine particles is in a range from 1% by mass to 60% by mass relative to a solid content of the ionizing radiation curable resin composition.

14. The hard coat film according to claim 3, wherein a content of the inorganic fine particles or the organic fine particles is in a range from 1% by mass to 60% by mass relative to a solid content of the ionizing radiation curable resin composition.

15. The hard coat film according to claim 4, wherein a content of the inorganic fine particles or the organic fine particles is in a range from 1% by mass to 60% by mass relative to a solid content of the ionizing radiation curable resin composition.

16. The hard coat film according to claim 9, wherein a content of the inorganic fine particles or the organic fine particles is in a range from 1% by mass to 60% by mass relative to a solid content of the ionizing radiation curable resin composition.

17. The hard coat film according to claim 10, wherein a content of the inorganic fine particles or the organic fine particles is in a range from 1% by mass to 60% by mass relative to a solid content of the ionizing radiation curable resin composition.

18. The hard coat film according to claim 11, wherein a content of the inorganic fine particles or the organic fine particles is in a range from 1% by mass to 60% by mass relative to a solid content of the ionizing radiation curable resin composition.

19. The hard coat film according to claim 12, wherein a content of the inorganic fine particles or the organic fine particles is in a range from 1% by mass to 60% by mass relative to a solid content of the ionizing radiation curable resin composition.
